(19) United States
(12) Patent Application Publication
(10) Pub. No.: US 2014/0327871 A1
(43) Pub. Date: Nov. 6, 2014

(54) Eyeglasses, Eyecups, and methods of use and doing business

(71) Applicant: Robert Hall, Ontario, CA (US)

(72) Inventor: Robert Hall, Ontario, CA (US)

(21) Appl. No.: 13/875,583

(22) Filed: May 2, 2013

(51) Int. Cl. G02C 11/00; G02C 11/08

(52) U.S. Cl. CPC G02C 11/12; G02C 11/08
USPC 351/62; 351/158

(57) ABSTRACT

Described herein are various embodiments of eyewear provided for advantageous use in sports, work, and casual activity. According to one embodiment, methods of retailing eyecup assemblies include a replenishment program for transmitting replacement eyecup assemblies to a purchaser at a regular interval. According to another embodiment, a method of retailing eyecup assemblies includes providing a retailer with eyecup assemblies differing from one another and providing the retailer with an eyeglasses frame. According to an embodiment, a method of retailing eyecup assemblies includes providing a retailer with eyecup assemblies differing from one another and without providing an eyeglasses frame. According to another embodiment, a kit having eyecup assemblies includes eyecup assemblies differing from one another and an eyeglasses frame. According to an embodiment, a kit having eyecup assemblies includes eyecup assemblies differing from one another without providing an eyeglasses frame.

### REFERENCE TO PENDING PRIOR PATENT APPLICATION

This is a divisional application to application Ser. No. 12/660,850 which was filed on Mar. 4, 2010 which is titled “Eyeglasses, Eyecups, and Methods of Use And Doing Business” which claims the priority of Provisional Application Ser. No. 61/167,432, which was filed on Mar. 4, 2009 which the patent applications are hereby incorporated by reference.

### FIELD

This disclosure pertains to eyewear. More particularly, this disclosure pertains to eyewear, including glasses and sunglasses, having an eyecup and methods of use and doing business.

### BACKGROUND

Eyeglasses and other eyewear has been used for treatment of dry eyes and other eye related afflictions. Typically, one or more sealing members are positioned between the eyewear and the user's face. These sealing members are typically configured to make a good seal with the user's face, but are also readily visible to others. These types of notorious displays of the sealing members renders the eyewear different than other user's eyewear. For children and other users, this may be a significant issue. Some users may opt not to wear eyewear with sealing members to avoid looking different than their peers. Others may not choose to purchase eyewear with readily visible sealing members.

Dry eye conditions affect many people in various life stages. In particular, more women than men tend to have issues with dry eyes and may use eye drops for treatment. Such eye drops tend to be relatively expensive and disruptive to reapply at numerous times in a day. Eyewear to retain moisture with or without the application of medicinal eye drops has been used by some people with dry eyes. However, many women and men are not comfortable wearing bulky and unfashionable eyewear. Furthermore, the eyewear may become dirty or degraded over time due to contact with oils or makeup from a user's face. Due to these types of issues, users may not benefit from currently available eyewear.

In addition, wearing of eyeglasses and other eyewear while engaged in social activities, professional activities in an office environment, and other work tasks can be difficult for various reasons. One key reason is a fundamental inability of most eyeglass frames to appear aesthetically pleasing and also provide a protective seal around a wearer's eyes for preventing wind, dust, dirt, moisture, glare, ultraviolet radiation, and other contaminants and debris from contacting, and potentially damaging, the wearer's eyes.

Many people wear eyeglasses for reasons other than, or in addition to, vision correction. Well-known examples are the large number of different types of “sunglasses” that reduce the intensity (and/or change the wavelength) of light reaching the wearer's eyes. Other well-known examples are so-called “safety glasses” usually used for eye protection in industrial and laboratory environments. Yet other well-known examples are various “goggles” and the like.

As used herein, “eyewear” generally encompasses all of various eyeglass types summarized above as well as any other analogous device configured to fit to a person's face and that includes a “frame” and “lenses.” The frame typically has a front portion situated largely in front of the wearer's eyes. The lenses are mounted to the front portion and transmit at least some light to the wearer's eyes. Mounted to the front portion are “temple pieces” that extend rearward from the front portion to engage and/or rest upon the wearer's ears. The temple pieces usually, but not necessarily, are hinged to the front portion.

To address the concerns raised by the need for protection of the wearer's eyes during activity, various schemes have been adopted. For example, certain types of eyewear, notably safety goggles and certain types of eyeglasses, employ shields, liners, and other sealing members for protecting a wearer's eyes during use. Unfortunately, the sealing members of these types of eyewear are generally readily apparent and unsightly for many uses. Therefore, such eyewear may fail to provide overall pleasing comfort and adequate therapeutic effect for the wearer's eyes during activity, while also being able to provide sufficient venting, or retain the versatility from which, for example, extended wear may benefit.

Some schemes have been tried to improve the protection of a wearer's eyes by providing various types of sealing members. For example, one scheme involves adjusting the spacing between two lenses or pivoting eye cups to conform to the facial contour of a wearer. Another scheme involves inflating or deflating an inflatable cushion member to provide an adjustable seal against contaminants. A third scheme involves retracting or extending, such as by pivoting, retractable eyeshields to provide eye protection that can be adjusted to an individual wearer. Unfortunately, these various schemes tend to be highly specialized, have very noticeable sealing members, and do not address all needs, especially needs posed by concepts of style and utility that arise with modern eyeglasses.

Typically, eyeglasses and eyecup assemblies have been retailed as a unit without the ability to select separate components that may provide a better fit to a user. The fitter, eye care provider, or other retailer may be precluded from obtaining additional sales due to the lack of selection from separate components. Devices in the prior type have typically provided one set of eyecups per set of eyeglasses. Adapting to various faces and head shapes has thus long presented a serious problem.

Flexibility of eyecups has been implemented to some degree, such as with foam liners. But this can be uncomfortable for certain users and not provide any sealing at all for others.

Eyecup assemblies may wear out or otherwise become less desirable. When this happens, a user may be less apt to use the eyecup assembly. In addition, the expense of purchasing multiple eyecups at one time, traveling to a retail location to purchase new eyecups, or placing separate orders for eyecups may be inconvenient for a user. A more convenient system may be very beneficial to eyecup users.

### SUMMARY

Described herein are various embodiments of eyewear provided for advantageous use in sports and work, as well as in casual activity. The eyewear can have an eyecup assembly for providing a custom fit around the eyes and protecting the eyes from undesirable contaminants. In some embodiments, the eyewear can include flexible eyecups that are removable by actuation of an attachment mechanism, such as a magnetic connection, a tabbed connection, or both.

According to one embodiment, there may be provided methods of retailing eyecup assemblies. One method may include enrolling a purchaser of an initial eyecup assembly at an eye care provider (ECP) or retailer into a replenishment program to deliver replacement eyecup assemblies to the purchaser at a regular interval. The method may further include receiving information related to the purchaser enrolling into the replenishment program at a distributor or manufacturer from the ECP. The method may also include transmitting the replacement eyecup assemblies from the distributor to the purchaser at the regular interval.

According to another embodiment, there may be provided methods of retailing or otherwise distributing eyeglasses. One method may include providing a retailer with a plurality of eyecup assemblies with at least one of the plurality of eyecup assemblies differing from another one of the plurality of eyecup assemblies. Each of the eyecup assemblies may have a seal material extending from an eyecup frame. Each of the eyecup assemblies may be sized for engagement with facial portions surrounding both left and right eyes of a user. Each of the eyecup assemblies may have one or more attachment portions in attachment to the eyecup frame. The method may also include providing the retailer with an eyeglasses frame defining a pair of apertures. At least one lens may be disposed in each of the pair of apertures. One or more attachment devices may be in attachment to the eyeglasses frame. The attachment devices of the eyeglasses frame and the attachment devices of each of the eyecup assemblies may be configured for selective attachment with one another. This allows removable attachment of a selected one of the eyecup assemblies and the eyeglasses frame with one another.

In another embodiment, a method of retailing eyeglasses may include providing a retailer or other entity with a plurality of eyecup assemblies. At least one of the plurality of eyecup assemblies may differing from another one of the plurality of eyecup assemblies. Each of the eyecup assemblies may have a seal material extending from an eyecup frame. Each of the eyecup assemblies may be sized for engagement with facial portions surrounding both left and right eyes of a user. Each of the eyecup assemblies may have one or more attachment portions in attachment to the eyecup frame. Each of the one or more attachment portions of each of the eyecup assemblies may be configured for selective attachment with one or more attachment devices of an eyeglasses frame. This allows removable attachment of a selected one of the eyecup assemblies and the eyeglasses frame with one another.

According to one embodiment, there may be provided kits having eyecup assemblies and an eyeglasses frame. In an embodiment, the kit may include a plurality of eyecup assemblies provided together with one another. At least one of the plurality of eyecup assemblies may differ from another one of the plurality of eyecup assemblies. Each of the eyecup assemblies may have a seal material extending from an eyecup frame. Each of the eyecup assemblies may be sized for engagement with facial portions surrounding both left and right eyes of a user. Each of the eyecup assemblies may have one or more attachment portions in attachment to the eyecup frame. The kit may also include an eyeglasses frame defining a pair of apertures. At least one lens may be disposed in each of the pair of apertures. One or more attachment devices may be in attachment to the eyeglasses frame. The one or more attachment devices of the eyeglasses frame and the one or more attachment devices of each of the eyecup assemblies being configured for selective attachment with one another. This allows removable attachment of a selected one of the eyecup assemblies and the eyeglasses frame with one another.

According to an embodiment, there may be provided a kit having eyecup assemblies together, without an eyeglasses frame, and with at least one of the eyecup assemblies differing from another one of the eyecup assemblies. Each of the eyecup assemblies may have a seal material extending from an eyecup frame. Each of the eyecup assemblies sized for engagement with facial portions surrounding both left and right eyes of a user. Each of the eyecup assemblies may have one or more attachment portions in attachment to the eyecup frame. The attachment portions of each of the eyecup assemblies may be configured for selective attachment with attachment devices of an eyeglasses frame. This allows removable attachment of a selected one of the eyecup assemblies and the eyeglasses frame with one another.

According to another embodiment, an eyeglass can include a frame and an eyecup assembly removably coupled to the frame. The eyecup assembly can include a seal material extending from an eyecup frame. The eyecup assembly can also be sized for engagement with both left and right eyes of a user. One or more attachment portions may be disposed in attachment to the eyecup frame. An eyeglasses frame may define a pair of apertures. At least one lens is disposed in each of the pair of apertures. One or more attachment devices may be in attachment to the eyeglasses frame. The attachment devices of the eyeglasses frame and the attachment portions of the eyecup assembly may be configured for selective attachment with one another so as to allow removable attachment of the eyecup assembly and the eyeglasses frame with one another.

In some implementations, the seal material is silicone. In other implementations, the seal is a plastic material. Still yet, the seal material may be a combination of materials, including one or more types of silicone or plastic used in combination with one another.

In some implementations, the eyecup frame may include at least one vent. The vent may be formed through the eyecup frame, and may be surrounded by one or both of the eyecup frame and the eyeglasses frame.

In some implementations, the attachment portions of the eyecup assembly can include metal portions. The attachments devices of the eyeglasses frame may include magnetic portions.

In some implementations, the eyecup assembly can be a modular self-contained unit.

In some implementations, the eyecup frame may include one or more tabs extending therefrom. The eyeglasses frame may form one or more slots therein. The one or more tabs and the one or more slots may be configured to engage with one another so as to removably attach the eyecup assembly and the eyeglasses frame with one another.

In some implementations, certain embodiments can aid in preventing or treating dry eye, dysfunctional tear syndrome, ocular surface disease, or other possible problems or disorders of the eye.

It is to be understood that the foregoing is a summary of certain aspects or features of embodiments disclosed herein. Embodiments of the invention need not necessarily include all such aspects or features or address issues noted in the Background. The foregoing and other features and advantages will become more apparent from the following detailed description, which proceeds with reference to the accompanying figures.

### BRIEF DESCRIPTION OF THE DRAWINGS

Illustrative embodiments of the invention are illustrated in the drawings, in which:

FIG. 1A illustrates a perspective view of an eyecup assembly at an angle with generally upwardly extending seal material.

FIG. 1B illustrates another perspective view of the eyecup of FIG. 1 at an angle with generally downwardly extending seal material.

FIG. 2 illustrates a plan view of the eyecup assembly with a direct view of a eyeglasses engaging portion with the seal material hidden from view.

FIGS. 2A-2C illustrate schematic partial perspective views of vents for airflow as well as attachment portions and a tab for securing the eyecup assembly to the eyeglasses frame.

FIG. 3A is a top plan view of a pair of eyeglasses.

FIG. 3B is a rear plan view of the pair of eyeglasses of FIG. 3B.

FIGS. 3C and 3D are schematic partial perspective views of portions of the pair of eyeglasses in FIGS. 3A and 3B, including magnets and a slot for attachment with the eyecup assembly illustrated in FIGS. 1A, 1B, and 2.

FIG. 4A is a top plan view of the eyecup assembly of FIG. 1A in attachment with the pair of eyeglasses of FIG. 3A.

FIG. 4B is a rear plan view of the eyecup assembly of FIG. 1A in attachment with the pair of eyeglasses of FIG. 3A.

FIGS. 4C and 4D are schematic partial perspective views of the eyecup assembly and the pair of eyeglasses in FIGS. 4A and 4B in attachment with one another.

FIG. 5 is a perspective rear view of the eyecup assembly and the pair of eyeglasses in FIGS. 4A and 4B slightly apart from one another.

FIG. 6 is a schematic partial perspective view of the eyecup assembly and the pair of eyeglasses slightly separated from one another with the tab and the slot in alignment with one another.

FIGS. 7-9 illustrate various perspective views of the eyecup assembly in attachment with the pair of eyeglasses.

FIG. 10 illustrates a perspective rear view of the eyecup assembly.

FIG. 11 illustrates a perspective forward view of the eyecup assembly.

FIG. 12 illustrates a partial perspective forward view of the eyecup assembly.

FIG. 13 illustrates a partial bottom perspective view of the eyecup assembly in attachment with the pair of eyeglasses.

FIG. 14 illustrates an exemplary embodiment of a bottom perspective view of an eyecup assembly in attachment with a pair of eyeglasses.

FIG. 15 illustrates a top perspective view of the eyecup assembly of FIG. 14 in attachment with the pair of eyeglasses.

FIG. 16 illustrates a rear perspective view of the eyecup assembly of FIG. 14 in attachment with the pair of eyeglasses.

FIG. 17 illustrates another top perspective view of the eyecup assembly of FIG. 14 in partial attachment with the pair of eyeglasses.

FIG. 18 illustrates a rear perspective view of the eyecup assembly of FIG. 14 detached from the pair of eyeglasses.

### DETAILED DESCRIPTION

This disclosure is set forth in the context of representative embodiments that are not intended to be limiting in any way.

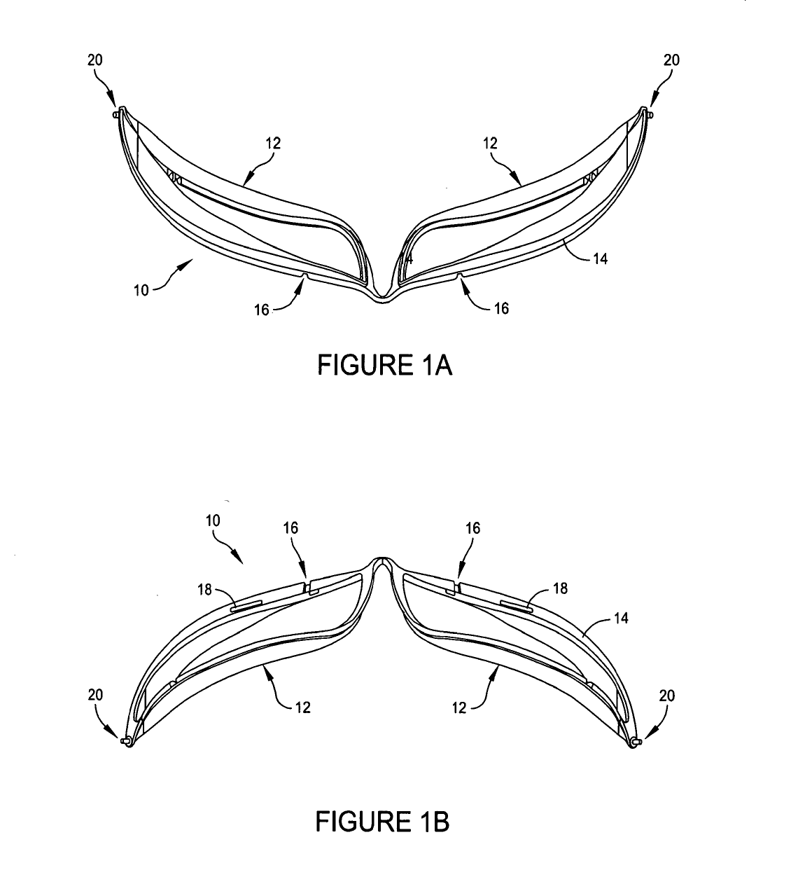

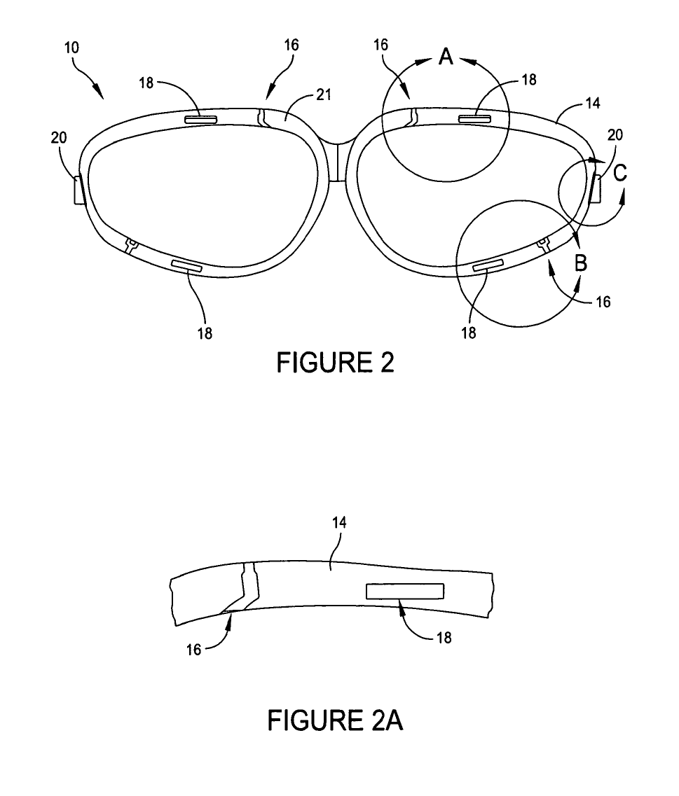

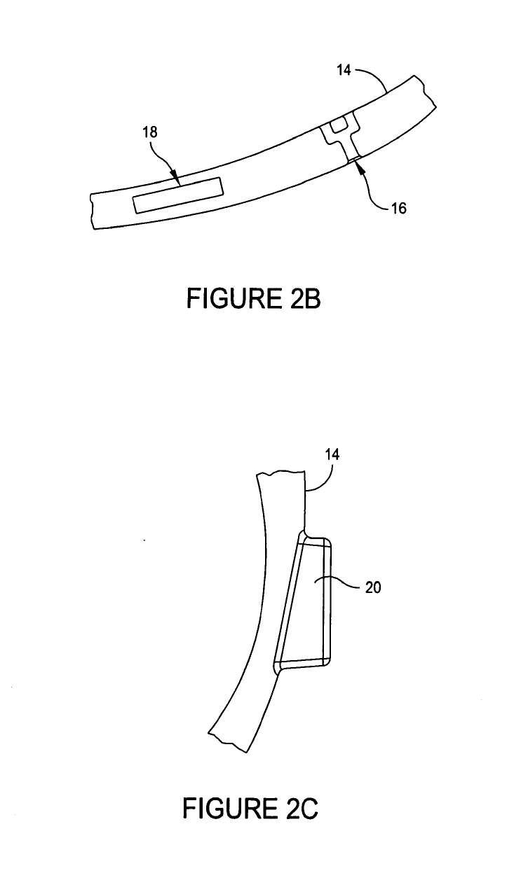

Referring to FIGS. 1A, 1B, 2, 2A, 2B and 2C, and in an embodiment, there is provided an eyecup assembly 10 with seal material 12 extending from eyecup frame 14. Seal material 12 generally extends away from eyecup frame 14 toward the face of a user. Seal material 12 may be provided in a substantially continuous extension from eyecup frame 14. This substantially continuous extension may form a sealed space therein when seal material 12 abuts the face of a user. Eyecup assembly 10 may be formed as a single portion (i.e., both lenses are contained in a single eyecup assembly structure) with seal material 12 disposed for engagement with portions of the face adjacent to both the left and right eyes of a user. Eyecup frame 14 may be formed out of a single material or multiple materials. Eyecup frame 14 could also include other removable eyeglass components, such as eyeglass side arms, to accommodate differing head shapes and sizes. For example, one set of side arms might be a given length and others might be ¼ or ½ inches longer, in increments from which the fitter or user might select in order to adapt the eyeglasses to the user's unique distance between the nose bridge and ears. Seal material 12 may be formed from the same material or a different material forming eyecup frame 14. For example, seal material 12 may be formed from silicone, plastic, or a combination of both.

In one embodiment, seal material 12 may extend away from eyecup frame 14 (toward the face of a user) and have a thinner transverse cross-section than a transverse cross-section of eyecup frame 14. In an embodiment, seal material 12 and eyecup frame 14 may be formed of co-molded plastic and silicone. A less dense portion of the co-molded plastic and silicone may be positioned toward the face of the user.

One or more vents 16 may be positioned through eyecup frame 14. In an embodiment, vents 16 may be positioned through eyecup frame 14 on an eyeglasses engaging portion 21 (FIG. 2). Vents 16 may extend from a portion of eyecup frame 14 outside of a sealed chamber ultimately formed within seal material 12 when disposed on the user's face to a portion of eyecup frame inside of the sealed chamber. In an embodiment, vents 16 may be disposed through opposed top and bottom portions of eyecup frame 14 as well as through right side and left side portions of the eyecup frame 14 corresponding to each one of the user's eyes. Vents 16 in eyecup assembly 10 may be configured to control airflow to the user's eyes. Vents 16 may be channels or notches passing in a relatively straight trajectory through seal material 12. In other embodiments, vents 16 may include at least one angular bend to adjust airflow. Vents 16 may include one or more bifurcations to allow airflow, provide a select amount of resistance, and inhibit entry of unwanted matter. Vents 16 may be permanently disposed in an open position. In another embodiment, plugs may be provided for selectively closing vents 16. For example, plugs may include a mechanical assembly to open and close vents 16. In one embodiment, vents may be provided in a frame portion of the eyeglasses.

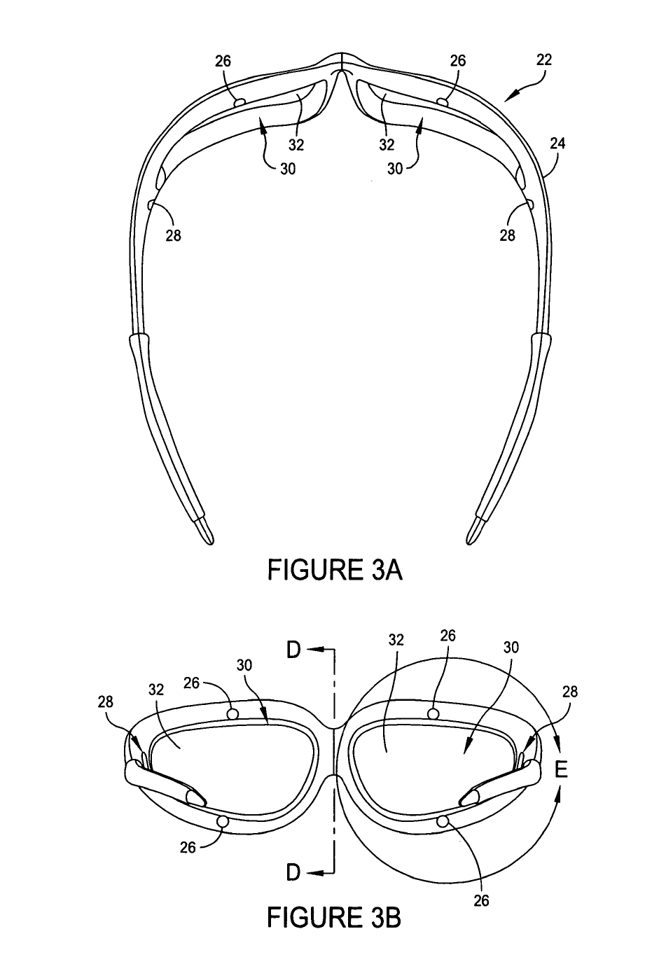

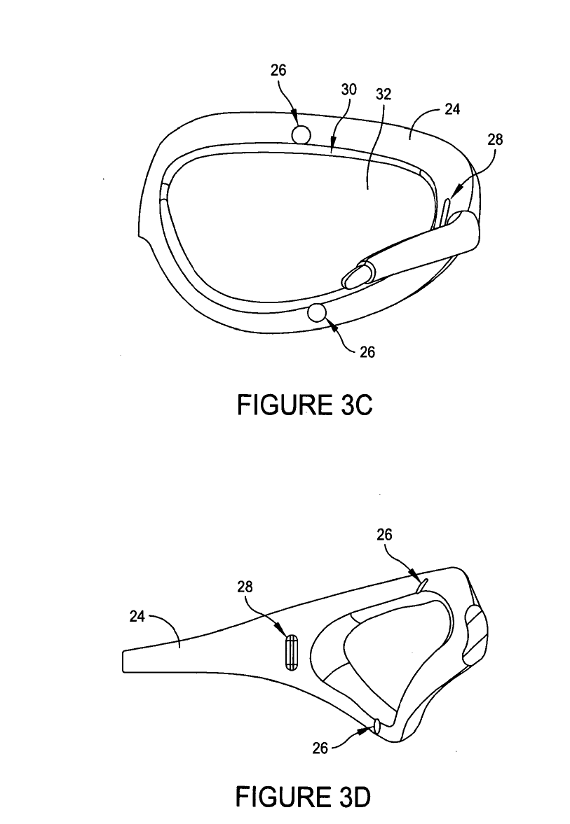

Attachment portions 18, which may be formed for a metal material 18, another magnetically attracting material 18, or magnets 18, may be provided in eyecup frame 14. Generally, attachment portions 18 are formed in both the upper and lower sections of the eyecup frame 14 on the side opposite to seal material 12. Attachment portions 18 may be disposed in a direction in opposition to seal material 12 in order to facilitate attachment with a set of eyeglasses. In other embodiments, attachment portions may be disposed in other orientations to facilitate attachment with a set of glasses. Attachment portions 18 may be elongated or spherical and may correspond in a substantially congruent manner to other features disposed on a set of eyeglasses. Attachment portions 18 may be disposed on opposed top and bottom portions of eyecup frame 14 as well as on right side and left side portions of eyecup frame 14 corresponding to each one of the user's eyes. This disposition of attachment portions 18 provides four points relatively dispersed from one another in order to allow a secure fit between eyecup frame 14 and a pair of eyeglasses. In addition, one or more tabs 20 may extend outwardly away from one another from the outside edges of frame 14 (near the temple region when worn by a user.) Tabs 20 may have a relatively squared off profile corresponding to a slot or other recess. Tabs 20 may be configured to secure eyecup assembly 10 to a pair of eyeglasses 22 (FIG. 3A.)

Eyecup assembly 10 has seal material 12 which may extend in a relatively low profile manner toward the face of a user. In an embodiment, this low profile manner relates to the cross-sectional width of seal material 12 when viewed from a direction orthogonal to a user's field of vision through the eyecup assembly. In various embodiments, seal material 12 may be transparent, clear, or otherwise blend into the eyeglasses so as to conceal its view when worn by the user. Exemplary views of seal material 12 are shown, for example, in FIG. 1A with the seal material extending upwardly away from the eyecup assembly and in FIG. 1B with the seal material extending downwardly away from the eyecup assembly.

As described above, seal material 12 may be configured such that it cannot be readily seen by others. Others looking at the user wearing eyecup 10 may only see eyecup frame 14, but not seal material 12, when looking at a direct view of the eyeglasses. For example, a direct view of an eyeglasses engaging portion 21 (FIG. 2) may hide seal material 12 behind eyeglasses engaging portion 21 due to the thin configuration of seal material 12. It should be appreciated that eyecup assembly 10 may be configured without any lenses disposed within the perimeter formed by seal material 12. However, in an alternative embodiment, eyecup assembly 10 may be provided with one or more lenses within the perimeter formed by seal material 12. These lenses in eyecup assembly may be separate from eyeglasses frame 24 (FIG. 3A.)

As discussed above, eyecup frame 14 may be provided with vent 16 and metal attachment portion 18. An exemplary view of vent 16 and metal attachment portion 18 are illustrated in an enlarged portion in FIGS. 2A and 2B. A tab 20 may extend from eyecup frame 14. For example, an enlarged view of tab 20 is shown in FIG. 2C Attachment portion 18 and tab 20 may be used either alone or in conjunction with one another to secure eyecup frame 14 to eyeglasses frame 24 (FIG. 3A).

In an embodiment, eyeglasses 22 may include an eyeglass frame 24. The eyeglass frame 24 may be a sunglass frame in particular in some embodiments. One or more magnets 26, or other attachment devices, such as a metal material or another magnetically attracting material, may be provided for attachment of eyeglass frame 24 with metal material 18 attached to eyecup frame 14. Magnets 26 may be positioned on one or both of eyecup frame 14 and eyeglasses frame 24. Magnets or other attachment devices 26 may be disposed through opposed top and bottom portions of eyeglasses frame 24 as well as through right side and left side portions of the eyecup frame 14 corresponding to each one of the user's eyes. Magnets or other attachment devices 26 may be disposed in a direction toward a user's face when disposed on the user. This disposition of magnets or other attachment devices 26 provides four points relatively dispersed from one another in order to allow a secure fit between eyecup frame 14 and eyeglass frame 24 of pair of eyeglasses 22. For example, exemplary views of eyeglass frame 24 are shown in FIGS. 3A and 3B.

Frame 24 may form one or more slots 28 for removable attachment of one or tabs 20. Slots 28 may be disposed toward a user's face when frame 24 is worn and may be elongated in a vertical orientation corresponding to tabs 20 of eyecup frame 14. Attachment of tabs 20 with slots 28 removably attach eyecup frame 14 with eyeglasses frame 24 so as to attach eyecup assembly 10 with eyeglasses 22. Eyeglasses frame 24 may form a pair of apertures 30, which may each contain at least one lens 32, and this lens 32 may be transparent or it may varying of translucency, coloration, or photoactivity, among many other possible characteristics for differing applications, uses, etc. In one embodiment, eyeglasses frame extends in a substantially surrounding configuration to two lenses 32, which are each provided to correspond substantially with a user's two eyes. In an embodiment, the user may wear eyeglasses 22 either with or without eyecup assembly 10 attached in place.

A partial view of eyeglasses frame 24 with magnets 26 on top and bottom portions for engagement with metal portions 18 of eyecup assembly 10 is shown in FIG. 3C. An exemplary view of slot 28 for eyecup tab 20 is shown in FIG. 3D.

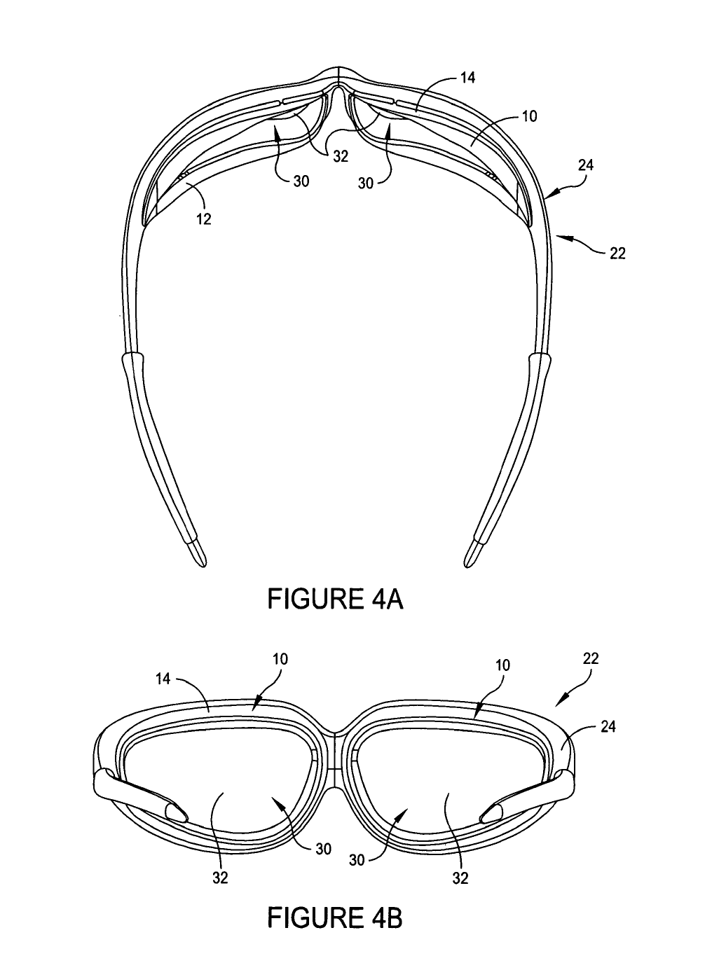

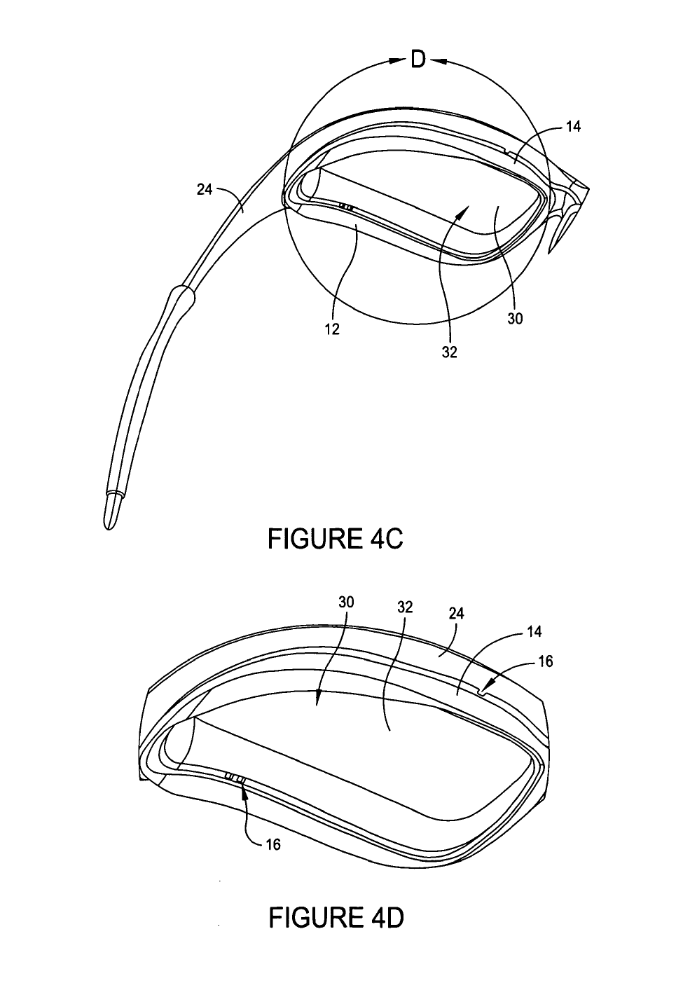

Eyeglasses 22 and eyecup assembly 10 may be selectively positioned in attachment with one another with seal material 12 substantially concealed from the view of others when worn by a user. For example, concealed nature of seal material 12 is illustrated in FIGS. 4A-4D. Eyeglasses 22 and eyecup assembly 10 may be configured to mate with one another such that sealing material 12 provides protection to the user while eyecup frame 14 is disposed a significant distance away from the user's face. This low-profile configuration may provide comfort and usability of eyeglasses 22 with eyecup assembly 10 in use together with, or removed from, eyeglasses frame 24. The concealed nature of seal material 12 also provides a cosmetic nature that many users prefer as others are not distracted by a set of glasses with a prominent sealing structure.

Eyeglasses 22 and eyecup assembly 10 may be disengaged from one another for cleaning or selection of seal material 12. For example, this disengagement allows replacement, repair, resizing, or refitting of the eyecup assembly 10. In an embodiment, eyeglasses 22 may include multiple fit options by providing two or more different sized eyecup assemblies. Replacement of eyecup assembly 10 with eyeglasses 22 may be important for many reasons. One reason may include providing new eyecups in place of worn eyecups. Another reason may be to change the color, style or some other feature of the eyecups with another desired feature (e.g., change tan eyecups to see-through eyecups.) Eyecups may be provided with designs or themes, such as the replaceable “skin” of a mobile telephone. Yet another reason may be to adapt the eyecups to different conditions such as, but not limited to, dry weather or rainy weather. Eyecups may include differing types of vents in various ones of the eyecup assemblies. The many different kinds of eyecup assemblies may also provide a new business model for optometrists and others selling these types of eyeglasses 22 with eyecup assembly 10. This recurring revenue may be from salves of eyeglasses with one or more sets of eyecups, or just from the sale of replacement, upgraded, or designer eyecups. Eyecup assembly 10 may also be designed for substitution when a user's face changes or the eyecups simply wear out.

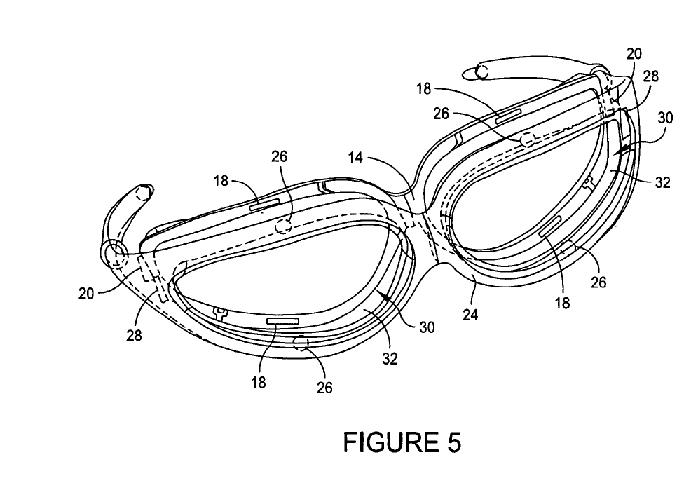

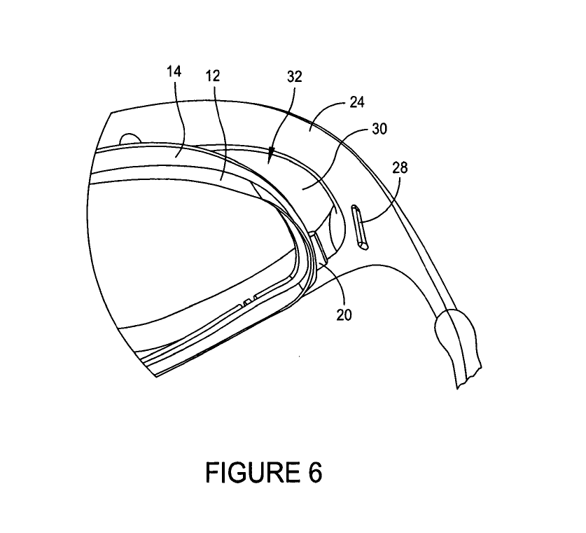

For example, FIG. 5 illustrates eyeglasses 22 and eyecup assembly 10 in a configuration slightly apart from one another. In this position, magnets 26 and metal portions 18 generally align with one another. When not in use, the removable eyecup assembly 10 may be stored as a single piece. When additional eye protection is necessary or desirable, eyecup assembly 10 may be attached to eyeglasses 22 in a single step by placing eyecup frame 14 adjacent to eyeglasses frame 24. Tabs 20 may be inserted into slots 28 for an additional securing of eyecup frame 14 to eyeglass frame 24. For example, tab 20 is shown slightly removed from slot 28 in FIG. 6.

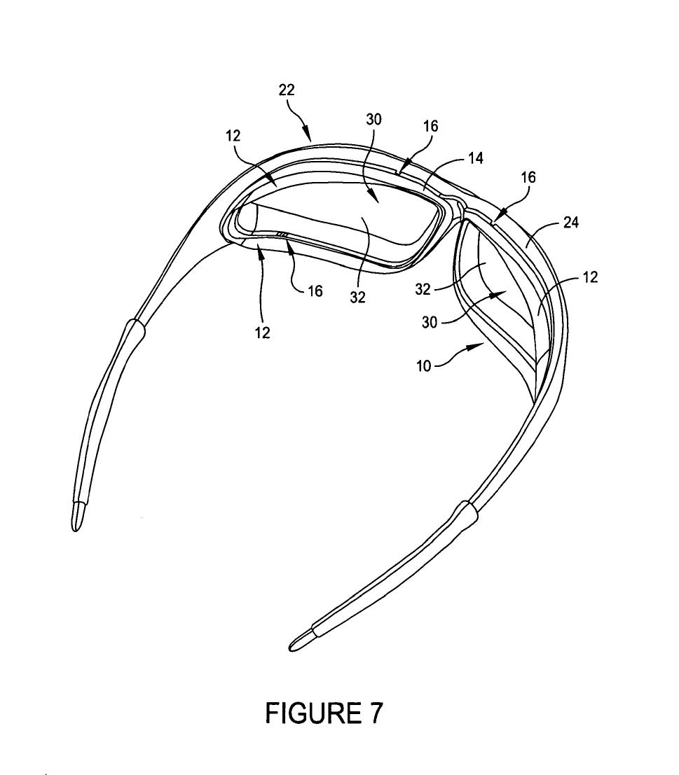

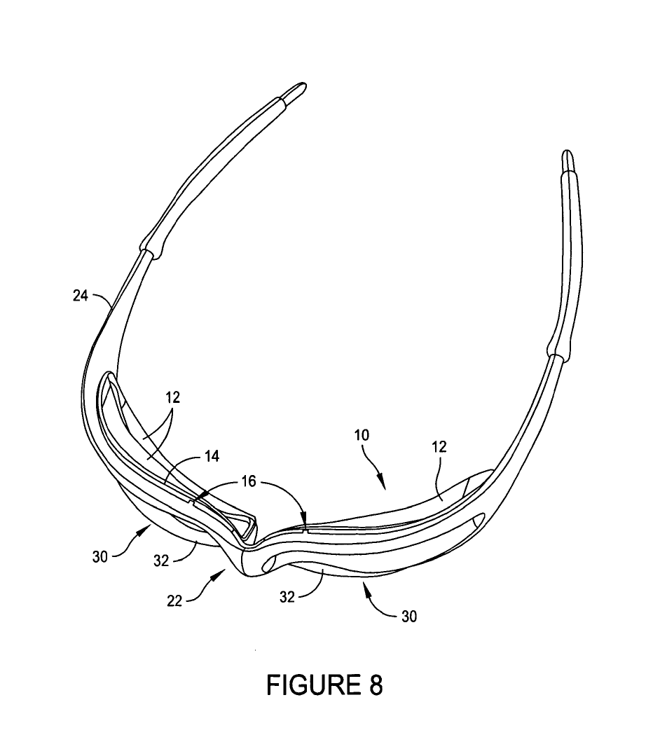

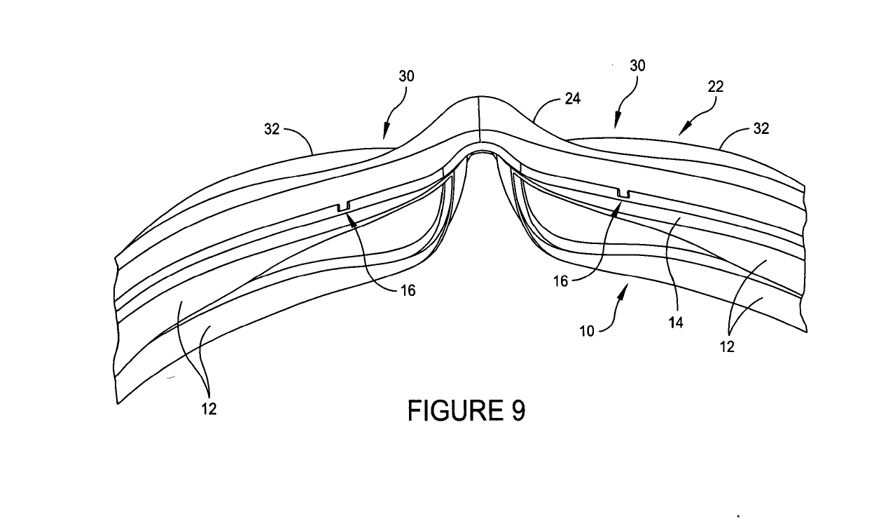

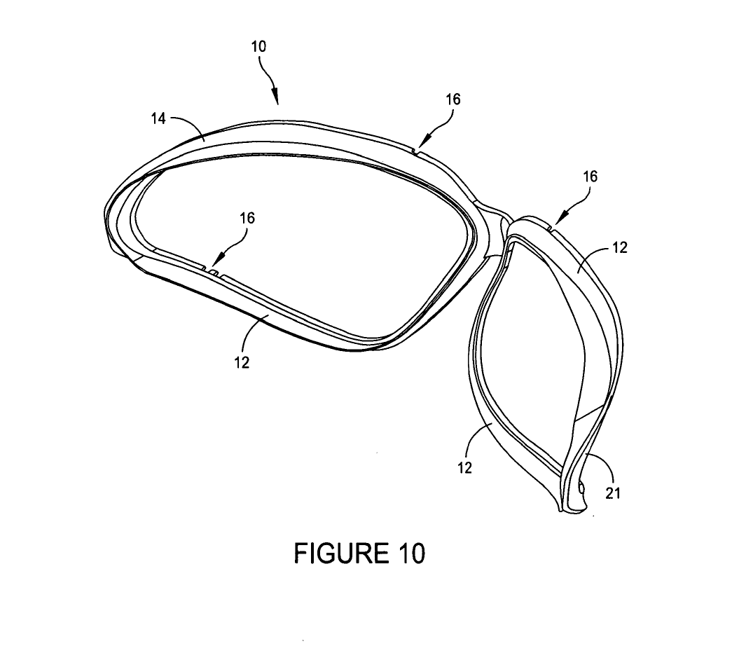

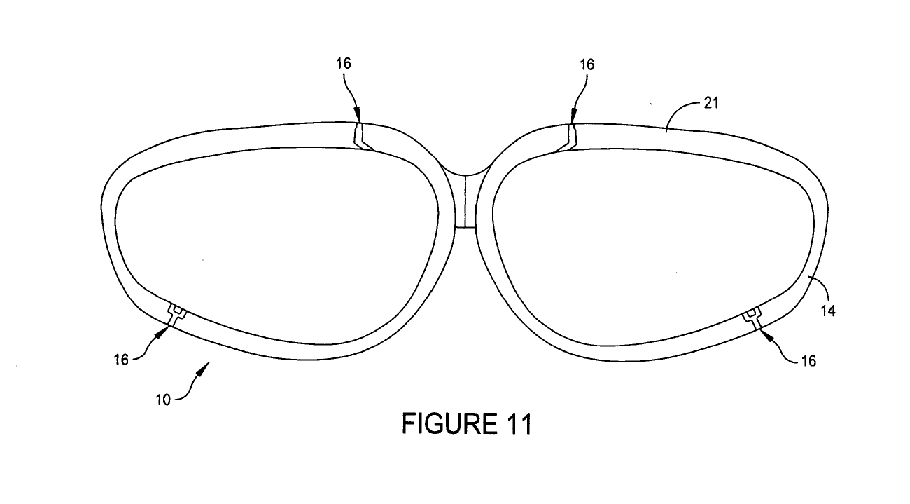

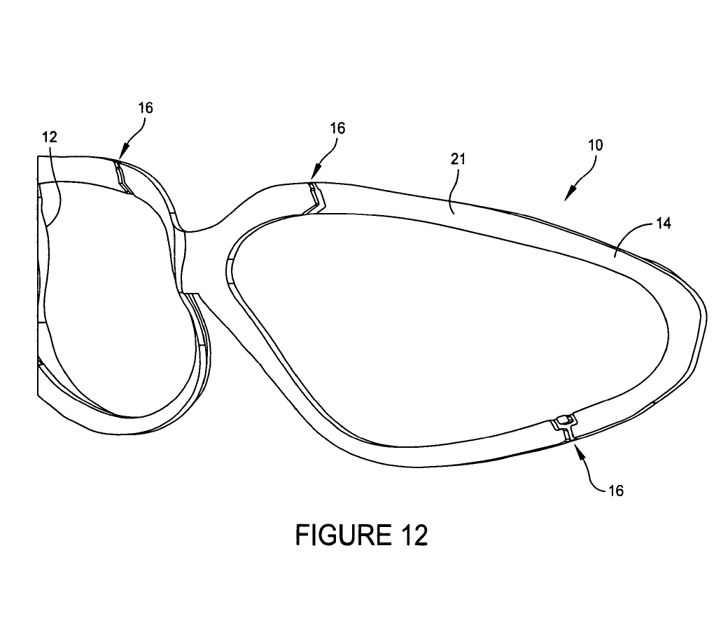

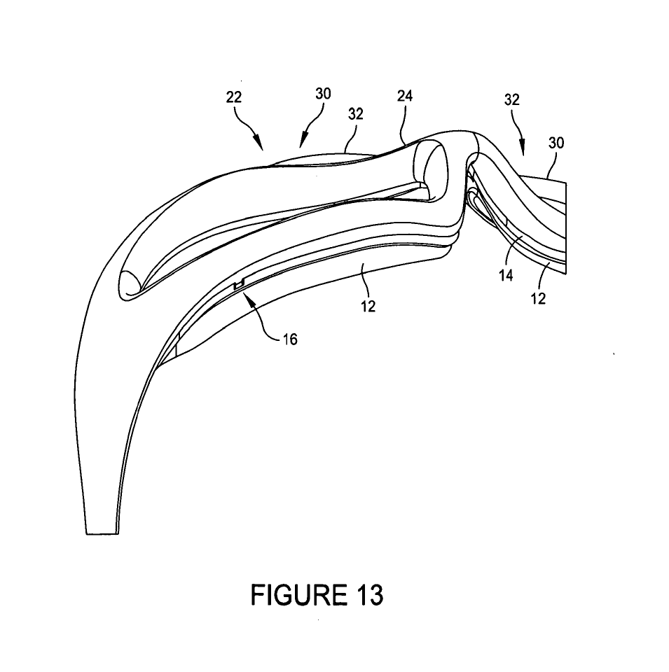

Various exemplary illustrations of eyeglasses 22 with eyecup assembly 10 in engagement with one another are provided by FIGS. 7-9 and 13. Eyecup assembly 10 may be separated from eyeglasses 22 and is shown apart from eyeglasses 22 in FIGS. 10-12. Eyecup frame 14 may be flexible and is shown being twisted in FIG. 10. In various embodiments, eyecup frame 10 may be significantly more flexible than eyeglasses frame 24.

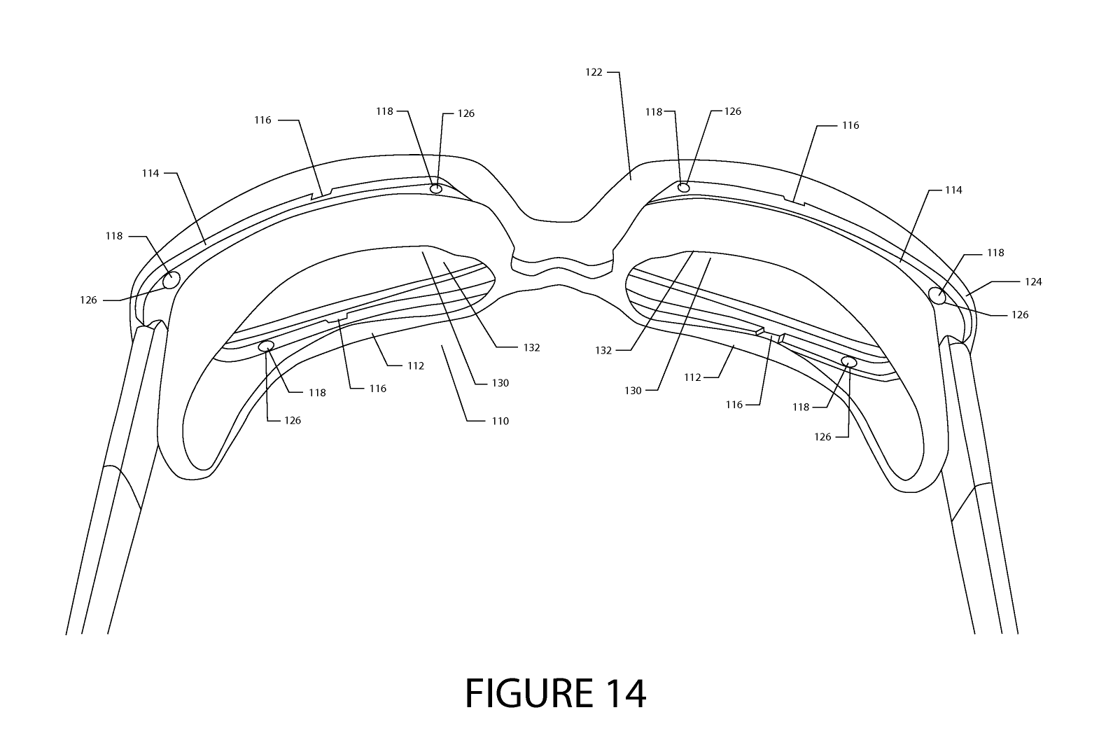

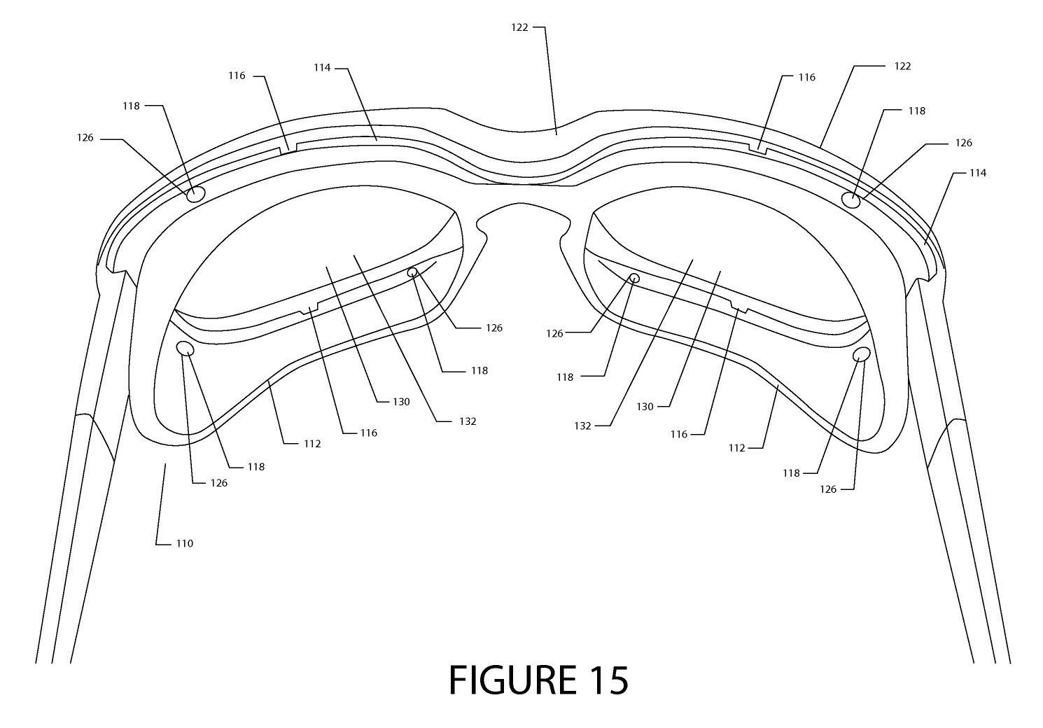

Referring to FIGS. 14-18, and in another exemplary embodiment, there is provided an eyecup assembly 110 with seal material 112 extending from eyecup frame 114. Seal material 112 generally extends away from eyecup frame 114 toward the face of a user. Seal material 112 may be provided in a substantially continuous extension from eyecup frame 114. This substantially continuous extension may form a sealed space therein when seal material 112 abuts the face of a user. Eyecup assembly 110 may be formed as a single portion (i.e., both lenses are contained in a single eyecup assembly structure) with seal material 112 disposed for engagement with portions of the face adjacent to both the left and right eyes of a user. Eyecup frame 114 may be formed out of a single material or multiple materials. Eyecup frame 114 could also include other removable eyeglass components, such as eyeglass side arms, to accommodate differing head shapes and sizes. For example, one set of side arms might be a given length and others might be ¼ or ½ inches longer, in increments from which the fitter or user might select in order to adapt the eyeglasses to the user's unique distance between the nose bridge and ears. Seal material 112 may be formed from the same material or a different material forming eyecup frame 114. For example, seal material 112 may be formed from silicone, plastic, or a combination of both.

In one embodiment, seal material 112 may extend away from eyecup frame 114 (toward the face of a user) and have a thinner transverse cross-section than a transverse cross-section of eyecup frame 114. In an embodiment, seal material 112 and eyecup frame 114 may be formed of co-molded plastic and silicone. A less dense portion of the co-molded plastic and silicone may be positioned toward the face of the user.

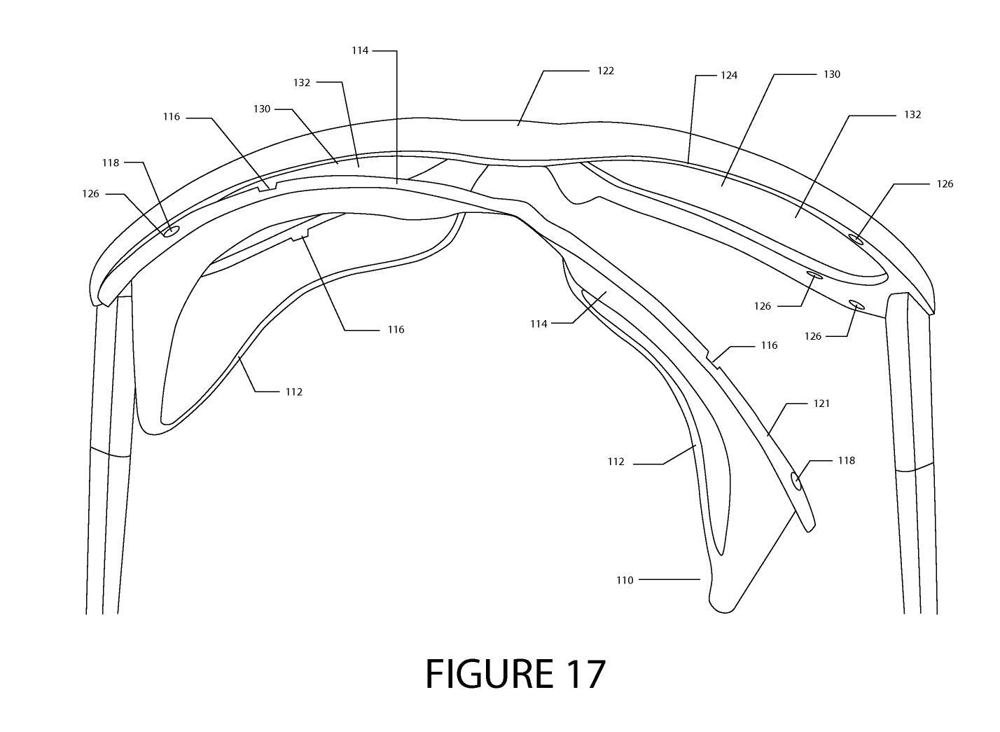

One or more vents 116 may be positioned through eyecup frame 114. In an embodiment, vents 116 may be positioned through eyecup frame 114 on an eyeglasses engaging portion 121 (FIG. 17). Vents 16 may extend from a portion of eyecup frame 114 outside of a sealed chamber ultimately formed within seal material 112 when disposed on the user's face to a portion of eyecup frame inside of the sealed chamber. In an embodiment, vents 116 may be disposed through opposed top and bottom portions of eyecup frame 114 as well as through right side and left side portions of the eyecup frame 114 corresponding to each one of the user's eyes. Vents 116 in eyecup assembly 110 may be configured to control airflow to the user's eyes. Vents 116 may be channels or notches passing in a relatively straight trajectory through seal material 112. In other embodiments, vents 16 may include at least one angular bend to adjust airflow. Vents 116 may include one or more bifurcations to allow airflow, provide a select amount of resistance, and inhibit entry of unwanted matter. Vents 116 may be permanently disposed in an open position. In another embodiment, plugs may be provided for selectively closing vents 116. For example, plugs may include a mechanical assembly to open and close vents 116. In one embodiment, vents may be provided in a frame portion of the eyeglasses.

Attachment portions 118, which may be formed for a metal material 18, another magnetically attracting material 118, or magnets 118, may be provided in eyecup frame 114. Generally, attachment portions 18 are formed in both the upper and lower sections of the eyecup frame 114 on the side opposite to seal material 112. Attachment portions 18 may be disposed in a direction in opposition to seal material 112 in order to facilitate attachment with a set of eyeglasses. In other embodiments, attachment portions may be disposed in other orientations to facilitate attachment with a set of glasses. Attachment portions 118 may be elongated or spherical and may correspond in a substantially congruent manner to other features disposed on a set of eyeglasses. Attachment portions 118 may be disposed on opposed top and bottom portions of eyecup frame 114 as well as on right side and left side portions of eyecup frame 114 corresponding to each one of the user's eyes. This disposition of attachment portions 118 provides four points relatively dispersed from one another in order to allow a secure fit between eyecup frame 114 and a pair of eyeglasses.

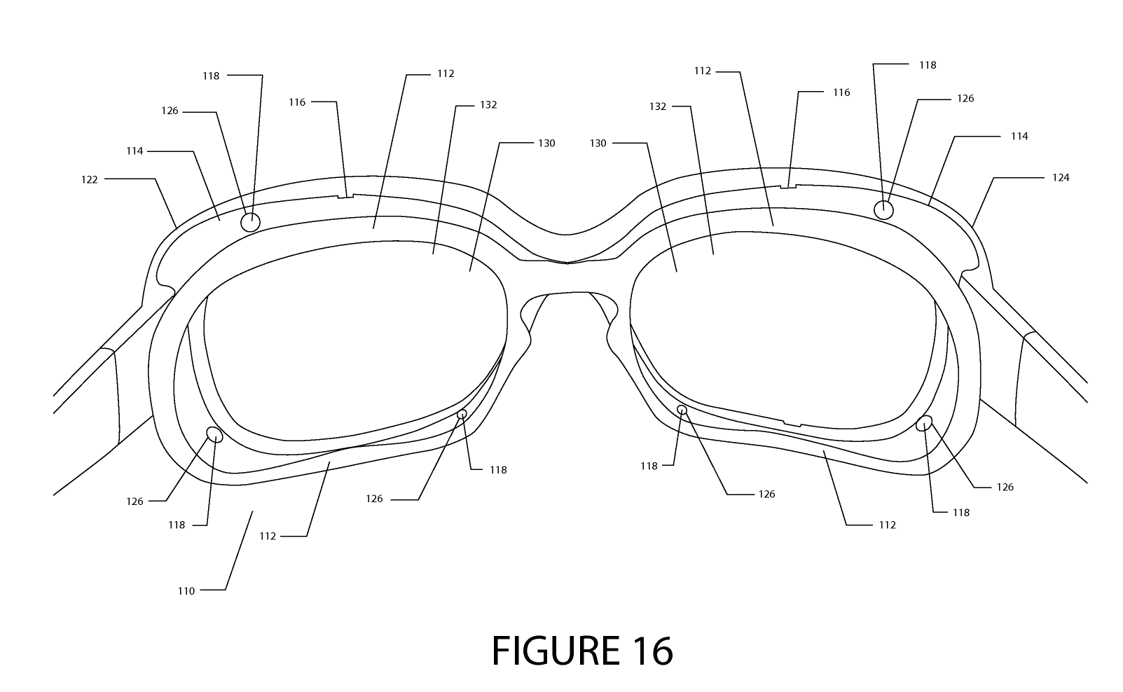

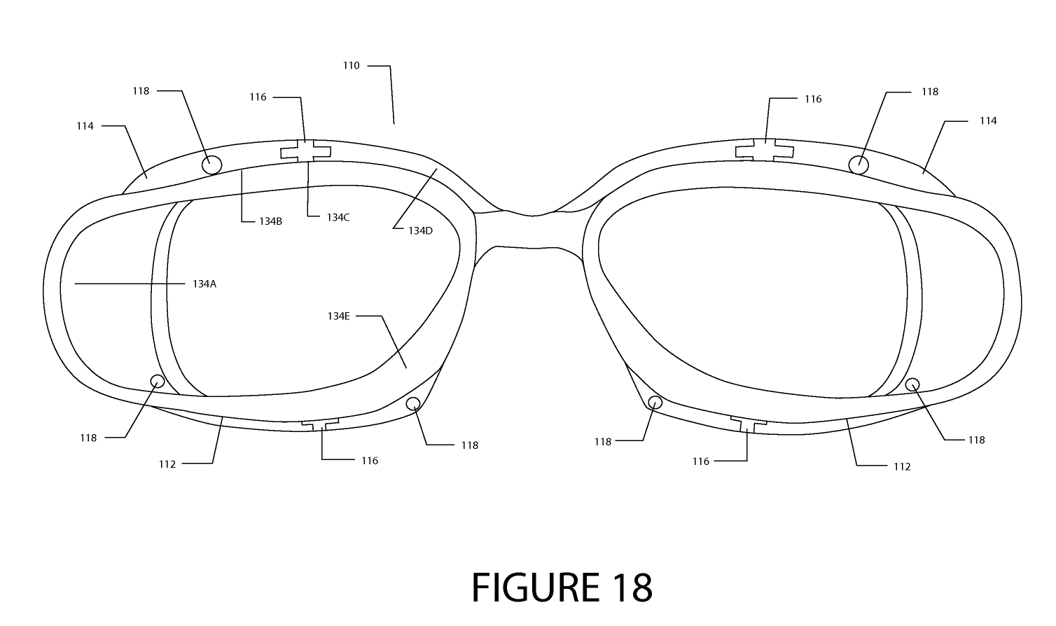

Eyecup assembly 110 has seal material 112 which may extend in a relatively low profile manner toward the face of a user. In an embodiment, this low profile manner relates to the cross-sectional width of seal material 112 when viewed from a direction orthogonal to a user's field of vision through the eyecup assembly. In various embodiments, seal material 112 may be transparent, clear, or otherwise blend into the eyeglasses so as to conceal its view when worn by the user. Exemplary views of seal material 112 are shown, for example, in FIG. 14 and with the seal material extending downwardly away from the eyecup assembly and in FIGS. 16 and 18 with the seal material extending outwardly away from the eyecup assembly.

As described above, seal material 112 may be configured such that it cannot be readily seen by others. Others looking at the user wearing eyecup 110 may only see eyecup frame 114, but not seal material 112, when looking at a direct view of the eyeglasses. For example, a direct view of an eyeglasses engaging portion 121 (FIG. 17) may hide seal material 112 behind eyeglasses engaging portion 121 due to the thin configuration of seal material 112. It should be appreciated that eyecup assembly 110 may be configured without any lenses disposed within the perimeter, formed by seal material 112. However, in an alternative embodiment, eyecup assembly 110 may be provided with one or more lenses within the perimeter formed by seal material 112. These lenses in eyecup assembly may be separate from eyeglasses frame 124 (FIGS. 14-17.)

Referring to FIG. 18, seal material 112 may extend at differing distances from eyecup frame 114. In one embodiment, eyecup frame 114 may have a thickness of about 2 mm from the side of eyeglasses engaging portion 121 (FIG. 17) to the side of seal material 112. Including the about 2 mm thickness of eyecup frame 114, seal material 112 may extend varying distances and, for example, may extend about 24 mm at 134A, about 18 mm at 134B, about 17 mm at 134C, about 6 mm at 134D, and about 10 mm at 134E.

In an embodiment, eyeglasses 122 may include an eyeglass frame 124. One or more magnets 126, or other attachment devices, such as a metal material or another magnetically attracting material, may be provided for attachment of eyeglass frame 124 with metal material 118 attached to eyecup frame 114. Magnets 126 may be positioned on one or both of eyecup frame 114 and eyeglasses frame 124. Magnets or other attachment devices 126 may be disposed through opposed top and bottom portions of eyeglasses frame 124 as well as through right side and left side portions of the eyecup frame 114 corresponding to each one of the user's eyes. Magnets or other attachment devices 126 may be disposed in a direction toward a user's face when disposed on the user. This disposition of magnets or other attachment devices 126 provides four points relatively dispersed from one another in order to allow a secure fit between eyecup frame 114 and eyeglass frame 124 of pair of eyeglasses 122. For example, exemplary views of eyeglass frame 124 are shown in FIG. 17.

Eyeglasses frame 124 may form a pair of apertures 130, which may each contain at least one lens 132. In one embodiment, eyeglasses frame extends in a substantially surrounding configuration to two lenses 132, which are each provided to correspond substantially with a user's two eyes. In an embodiment, the user may wear eyeglasses 122 either with or without eyecup assembly 110 attached in place.

Eyeglasses frame 124 with magnets 126 on top and bottom portions for engagement with metal portions 118 of eyecup assembly 110 is shown in FIG. 17.

Eyeglasses 122 and eyecup assembly 110 may be selectively positioned in attachment with one another with seal material 12 substantially concealed from the view of others when worn by a user. For example, concealed nature of seal material 112 is illustrated in FIG. 16. Eyeglasses 122 and eyecup assembly 110 may be configured to mate with one another such that sealing material 12 provides protection to the user while eyecup frame 114 is disposed a significant distance away from the user's face. This low-profile configuration may provide comfort and usability of eyeglasses 122 with eyecup assembly 110 in use together with, or removed from, eyeglasses frame 124. The concealed nature of seal material 112 also provides a cosmetic nature that many users prefer as others are not distracted by a set of glasses with a prominent sealing structure.

Eyeglasses 122 and eyecup assembly 110 may be disengaged from one another for cleaning or selection of seal material 112. For example, this disengagement allows replacement, repair, resizing, or refitting of the eyecup assembly 110. In an embodiment, eyeglasses 122 may include multiple fit options by providing two or more different sized eyecup assemblies. Replacement of eyecup assembly 110 with eyeglasses 122 may be important for many reasons. One reason may include providing new eyecups in place of worn eyecups. Another reason may be to change the color, style or some other feature of the eyecups with another desired feature (e.g., change tan eyecups to see-through eyecups.) Eyecups may be provided with designs or themes, such as the replaceable “skin” of a mobile telephone. Yet another reason may be to adapt the eyecups to different conditions such as, but not limited to, dry weather or rainy weather. Eyecups may include differing types of vents in various ones of the eyecup assemblies. The many different kinds of eyecup assemblies may also provide a new business model for optometrists and others selling or otherwise distributing or using these types of eyeglasses 122 with eyecup assembly 110. This recurring revenue may be from salves of eyeglasses with one or more sets of eyecups, or just from the sale of replacement, upgraded, or designer eyecups. Eyecup assembly 110 may also be designed for substitution when a user's face changes or the eyecups simply wear out.

For example, FIG. 17 illustrates eyeglasses 122 and eyecup assembly 110 in a configuration partially apart from one another. In this position, magnets 126 and metal portions 118 generally align with one another. When not in use, the removable eyecup assembly 110 may be stored as a single piece. When additional eye protection is necessary or desirable, eyecup assembly 110 may be attached to eyeglasses 122 in a single step by placing eyecup frame 114 adjacent to eyeglasses frame 124.

There may be provided various methods of providing a controlled ocular environment with a pair of eyeglasses having a substantially traditional appearance. In an embodiment, the method may include selecting an eyecup assembly with a seal material extending from an eyecup frame of the pair of glasses. The eyecup assembly may be selected to form a seal with at least a portion of the face of a user. In addition, the method may include selecting an eyeglasses frame together with the eyecup assembly to substantially conceal the seal material from view of others when worn by the user. The selected eyeglasses frame and the selected eyecup assembly may together provide the substantially traditional appearance on the face of the user.

In an embodiment, a method of automatically replacing eyecup assemblies is provided in which an eye care provider (ECP) or other retailer (such as an optometrist or other fitting professional) enrolls a purchaser of an initial eyecup assembly into a program with replacement eyecup assemblies delivered to the purchaser at a regular interval. For example, this regular interval may include one or more replacement eyecup assemblies being sent at a one, two, three, or six month interval. In addition, the distributor or manufacturer receives the enrollment information from the ECP and handles delivery of the replacement eyecup assemblies direct to the purchaser. This fulfillment process may be handled using a computer system to manage and track the timely delivery to the purchaser and also to handle the billing and collection of the associated charges with the customer.

Another advantage of this method includes the ability to share revenue between the distributor and the ECP. An incentive to the ECP to enroll the purchaser in this automatic replacement program is a cash credit or other payment made by the distributor of the eyecups to the ECP based on the additional eyecups sold directly to the purchaser. This revenue sharing program may be based on sales directly from enrollment with the ECP at the initial purchase. In addition, this revenue sharing program may be based on sales occurring subsequent to the initial purchase. For example, the ECP may direct the purchaser to enroll online through the Internet, through a telephone number, or by other methods. It should be appreciated that the revenue share provided to the ECP on a regular basis is a new marketing tool to stimulate initial sales and reoccurring sales of replacement eyecup assemblies.

Still another advantage of this method includes automatic replenishment and delivery of one or more eyecup assemblies to the purchaser and user of the eyecup and eyeglasses frame product. As one eyecup assembly begins to wear out or become less desirable to wear on a daily basis, the user will be provided with one or more additional eyecup assemblies as a replacement option. This automatic replenishment and replacement scenario may be similar to replacement of razorblades, toothbrushes, or other personal hygienic equipment that have a limited lifespan. This automatic replenishment method may ensure that a user with expensive eyeglasses will not stop using the eyecup assembly with the frames or quit using the eyeglasses entirely due to discomfort or less desirability of the eyecup assemblies with respect to aesthetic or hygienic issues.

In an embodiment, a method of retailing eyeglasses may include providing an ECP or other retailer or other distributor (such as an optometrist or other fitting professional) with a plurality of eyecup assemblies. At least one of the plurality of eyecup assemblies should differ from another one of the eyecup assemblies. In one embodiment, the eyecup assemblies have a seal material extending from an eyecup frame and are sized for engagement with facial portions surrounding both left and right eyes of a user. The eyecup assemblies have one or more attachment portions may be provided in attachment to the eyecup frame. In addition, the ECP may be provided with an eyeglasses frame defining a pair of apertures. At least one lens may be disposed in each of the pair of apertures. One or more attachment devices may be provided in attachment to the eyeglasses frame. Generally, the one or more attachment devices of the eyeglasses frame and the one or more attachment portions of each of the eyecup assemblies are configured for selective attachment with one another. This allows removable attachment of a selected one of the eyecup assemblies and the eyeglasses frame with one another.

The seal material of the plurality of eyecup assemblies may differ between the various eyecup assemblies. Differences may include, but are not limited to, differences in color, material, skin pattern (similar to a cell phone ornamental skin), or size.

In another embodiment, a method of retailing eyeglasses may include providing an ECP or other retailer or distributor (such as an optometrist or other fitting professional) with a plurality of eyecup assemblies, but not a particular eyeglasses frame, and one or more of the eyecup assemblies differ others of the eyecup assemblies. The one or more attachment portions of the eyecup assemblies are configured for selective attachment with one or more attachment devices of an eyeglasses frame provided separately from the eyecup assemblies. This allows removable attachment of a selected one of the eyecup assemblies and the eyeglasses frame with one another.

In an embodiment, a kit may be provided having eyecup assemblies and an eyeglasses frame. The kit may include a plurality of eyecup assemblies provided together with one another. At least one of the eyecup assemblies differ from another one of the eyecup assemblies. The eyecup assemblies have a seal material extending from an eyecup frame and are sized for engagement with facial portions surrounding both left and right eyes of a user. The eyecup assemblies have one or more attachment portions in attachment to the eyecup frame. The kit also includes an eyeglasses frame defining a pair of apertures. At least one lens may be disposed in each of the pair of apertures. One or more attachment devices are in attachment to the eyeglasses frame. The attachment devices of the eyeglasses frame and the attachment devices of the eyecup assemblies are configured for selective attachment with one another. This allows removable attachment of a selected one of the eyecup assemblies and the eyeglasses frame with one another.

In various embodiments, kits may include eyecup assemblies with different seal materials. These differences may include, but are not limited to, differences in color, material, skin pattern (similar to a cell phone ornamental skin), or size. The seal material may relatively permanently affixed to an associated eyecup or it may be more readily removable and replaceable, such as by providing a seal skin that adheres to the eyecup or associated structure by means of an adhesive allowing later removal and replacement of the seal skin, in some embodiments by means of additional adhesive on one side of the seal skin.

In another embodiment, a kit may include eyecup assemblies, but not a particular eyeglasses frame, and one or more of the eyecup assemblies differ others of the eyecup assemblies. The one or more attachment portions of the eyecup assemblies are configured for selective attachment with one or more attachment devices of an eyeglasses frame provided separately from the eyecup assemblies. This allows removable attachment of a selected one of the eyecup assemblies and the eyeglasses frame with one another.

Whereas the foregoing description is in the context of representative embodiments, the invention is not limited to those embodiments. On the contrary, the invention is intended to encompass all modifications, alternatives, and equivalents as may be included in the spirit and scope of the invention, as defined by the appended claims.

1. A kit having eyecup assemblies and an eyeglasses frame, the kit comprising: a plurality of eyecup assemblies provided together with one another with at least one of the plurality of eyecup assemblies differing from another one of the plurality of eyecup assemblies, each of the eyecup assemblies having a seal material extending from an eyecup frame, each of the eyecup assemblies sized for engagement with facial portions surrounding both left and right eyes of a user, and each of the eyecup assemblies having one or more attachment portions in attachment to the eyecup frame; and an eyeglasses frame defining a pair of apertures, at least one lens disposed in each of the pair of apertures, and one or more attachment devices in attachment to the eyeglasses frame, the one or more attachment devices of the eyeglasses frame and the one or more attachment portions of each of the eyecup assemblies being configured for selective attachment with one another so as to allow removable attachment of a selected one of the eyecup assemblies and the eyeglasses frame with one another.

2. A kit in accordance with claim 1, wherein the seal material of the plurality of eyecup assemblies differs between the at least one and the another one.

3. A kit in accordance with claim 1, wherein the seal material of the plurality of eyecup assemblies differs in color between the at least one and the another one.

4. A kit in accordance with claim 1, wherein the seal material of the plurality of eyecup assemblies differs in material between the at least one and the another one.

5. A kit in accordance with claim 1, wherein the seal material of the plurality of eyecup assemblies differs in skin pattern between the at least one and the another one.

6. A kit in accordance with claim 1, wherein the seal material of the plurality of eyecup assemblies differs in size between the at least one and the another one.

7. A kit in accordance with claim 1, wherein said eyecup frame is comprised of at least one or more vents.

8. A kit in accordance with claim 1, wherein at least one or more vents are formed when said eyecup frame attached to said eyeglasses frame.

9. A kit in accordance with claim 1, wherein at least one or more tabs are extending from said eyecup frame and at least one or more slots formed within said eyeglasses frame wherein said tabs are configured to engage with said slots.

10. A kit in accordance with claim 9, wherein said tab is comprised of at lease one magnet.

11. A kit in accordance with claim 1, wherein said seal material extending from an eyecup frame and seals against the face of a wearer.

12. A kit in accordance with claim 11, wherein said seal material is inflatable or deflatable to allow said seal material to seal against the face of said wearer.

13. A kit having eyecup assemblies, the kit comprising: a plurality of eyecup assemblies provided together with one another with at least one of the plurality of eyecup assemblies differing from another one of the plurality of eyecup assemblies, each of the eyecup assemblies having a seal material extending from an eyecup frame, each of the eyecup assemblies sized for engagement with facial portions surrounding both left and right eyes of a user, each of the eyecup assemblies having one or more attachment portions in attachment to the eyecup frame, and the one or more attachment portions of each of the eyecup assemblies being configured for selective attachment with one or more attachment devices of an eyeglasses frame so as to allow removable attachment of a selected one of the eyecup assemblies and the eyeglasses frame with one another.

14. A kit in accordance with claim 13, wherein the seal material of the plurality of eyecup assemblies differs between the at least one and the another one.

15. A kit in accordance with claim 13, wherein the seal material of the plurality of eyecup assemblies differs in color between the at least one and the another one.

16. A kit in accordance with claim 13, wherein said eyecup frame is comprised of at least one or more vents.

17. A kit in accordance with claim 13, wherein at least one or more vents are formed when said eyecup frame attached to said eyeglasses frame.

18. A kit in accordance with claim 13, wherein at least one or more tabs are extending from said eyecup frame and at least one or more slots formed within said eyeglasses frame wherein said tabs are configured to engage with said slots.
